(19) United States
(12) Patent Application Publication
(10) Pub. No.: US 2005/0190752 A1
(43) Pub. Date: Sep. 1, 2005

(54) Method and system for locating the incoming port of a MAC address in an Ethernet switch network

(76) Inventors: Cheng-Mau Chiou, Hsinchu City (TW); Jen-Tsung Shueh, Kaohsiung Hsien (TW); Chih-Cheng Yang, Hsinchu City (TW); Li-Chun Chao, Hsinchu City (TW); Kai-Yiu Chung, Hsinchu City (TW); Ting-Hang Chen, Tainan Hsien (TW)

Correspondence Address: RABIN & BERDO, P.C.;Suite 500, 1101 14 Street, N.W., Washington, DC, 20005, US

(21) Appl. No.: 11/025,064

(22) Filed: Dec. 30, 2004

(30) Foreign Application Priority Data
Feb. 27, 2004 (TW) 93105190

(51) Int. Cl. H04L 12/50; H04Q 11/00

(52) U.S. Cl. 370/360; 370/359

(57) ABSTRACT

A method for locating the incoming port of a MAC address is proposed. First, a forwarding table of each switch is retrieved. Then, a list of at least one MAC address owned by each switch is retrieved. Next, a port table of each switch is established. The MAC addresses in the forwarding table are compared with the MAC addresses owned by all switches. If one of the MAC addresses owned by switches matches the MAC address in the forwarding table, the port property of the corresponding port is changed to an interconnecting port. Finally, the target MAC address is compared with the MAC addresses in the forwarding table. If one of the MAC addresses in the forwarding table matches the target MAC address, and the port property of the corresponding port is end port, this port is the incoming port of the target MAC address.

### RELATED APPLICATIONS

The present application is based on, and claims priority from, Taiwan Application Serial Number 93105190, filed on Feb. 27, 2004, the disclosure of which is hereby incorporated by reference herein in its entirety.

### BACKGROUND

1. Field of Invention

The present invention relates to a method and a system for locating an incoming port. More particularly, the present invention relates to a method and a system for locating the incoming port of a MAC address in an Ethernet switch network.

2. Description of Related Art

In an Ethernet switch network, several computers connect to a single switch to form a local network. The connection of different switches from different local networks further constructs the entire Ethernet switch network. Every computer in an Ethernet switch network can interchange its own data with others. FIG. 1 illustrates an Ethernet switch network 10. Several computers 14 connect to a switch 12 to form a local network. Switches 12 from different local networks further connect to each other to construct the entire Ethernet switch network 10.

As the number of switches and computers increases in an Ethernet switch network, if an abnormal situation occurs in one computer, such as an unusually high data transferring volume or a virus attack, it often brings a catastrophic consequence to the entire Ethernet switch network. For example, when one computer is infected with a virus, this computer will continuously send out massive useless packets to the other computers in the entire Ethernet switch network. The bandwidth of Ethernet switch network becomes overwhelmed and paralyzed by the useless packets very quickly.

When this situation occurs, the network administrator often wants to locate where the abnormal computer is as soon as possible, so further procedures can be taken to minimize the impact and restore the Ethernet switch network back to normal.

In the prior art, when the network administrator wants to locate the abnormal computer, the approach is to disable every port of each switch in the entire Ethernet switch network one by one. If by disabling one particular port, the Ethernet switch network can be restored back to normal, the port is the one that the abnormal computer connects to.

However, this is actually trial-and-error and a tedious process. The network administrator has to examine every port of every switch in the entire Ethernet switch network to identify the abnormal computer. Most of the time, the entire Ethernet switch network is already paralyzed long before the network administrator is able to locate the abnormal computer.

For the forgoing reasons, there is a need for a method that can locate the incoming port of an abnormal computer in an Ethernet switch network more promptly and efficiently, so the network administrator can respond and take further action to restore the Ethernet switch network as soon as possible.

### SUMMARY

It is therefore an objective of the present invention to provide a method for locating the incoming port of a MAC address in an Ethernet switch network.

It is another objective of the present invention to provide a system that can locate the incoming port of a MAC address in an Ethernet switch network.

In accordance with the foregoing and other objectives of the present invention, a method for locating the incoming port of a MAC address in an Ethernet switch work is proposed. First, a forwarding table of each switch is retrieved. The forwarding table contains a list of all MAC addresses of packets passing through the switch, as well as the corresponding port that each packet enters the switch. Then, a list of at least one MAC address owned by each switch is retrieved. Next, a port table of each switch is established. The port table contains a list of all ports of the switch and a corresponding port property of each port. The default port property of each port is set to an end port. Afterward, the MAC addresses in the forwarding table of every switch is compared with the MAC addresses owned by all switches. If one of the MAC addresses owned by all switches matches the MAC address in the forwarding table of the switch, the port property of the corresponding port of that MAC address is changed to an interconnecting port in the port table. Finally, the target MAC address is compared with MAC addresses in the forwarding table of all the switches. If one of the MAC addresses in the forwarding table matches the target MAC address, and the port property of the corresponding port of that MAC address is an end port, this port is the incoming port of the target MAC address.

In accordance with another objective of the present invention, a system that can locate the incoming port of a MAC address in an Ethernet switch network is proposed. The system includes a forwarding table-retrieving module, a MAC address-retrieving module, a port table-establishing module, a port property-classifying module, and a target MAC address-comparing module. The forwarding table-retrieving module retrieves a forwarding table of each switch. The forwarding table contains a list of all MAC addresses of packets passing through the switch, as well as the corresponding port where each packet enters the switch. The MAC address-retrieving module retrieves a list of at least one MAC address owned by each switch. The port table-establishing module establishes a port table of each switch. The port table contains a list of all ports of the switch, and a corresponding port property of each port. The default port property of each port is set to an end port. The port property-classifying module compares the MAC addresses in the forwarding table of every switch with the MAC addresses owned by all switches. If one of the MAC addresses owned by all switches matches the MAC address in the forwarding table of the switch, the port property of the corresponding port of that MAC address is changed to an interconnecting port in the port table. The target MAC address-comparing module compares the target MAC address with the MAC addresses in the forwarding table of all switches. If one of the MAC addresses in the forwarding table matches the target MAC address, and the port property of the corresponding port of that MAC address is end port, this port is the incoming port of the target MAC address.

In conclusion, the present invention allows the network administrator to locate the incoming port of an abnormal computer in an Ethernet switch network promptly and take further action to restore the Ethernet switch network back to normal.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a diagram illustrating an Ethernet switch network in the prior art;

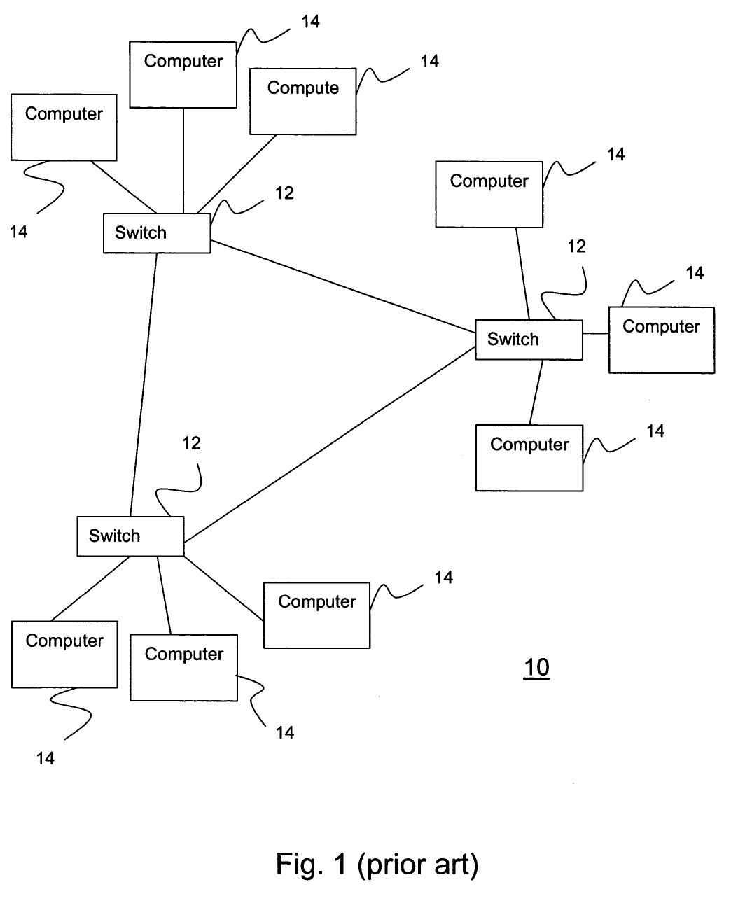

FIG. 2 is a flowchart demonstrating the method for locating the incoming port of a MAC address according to the present invention;

FIG. 3 is a diagram illustrating a switch network according to one preferred embodiment of the present invention;

FIG. 4 shows the forwarding tables, the port tables, and MAC addresses owned by all switches according to one preferred embodiment of the present invention;

FIG. 5 shows the port tables of all switches according to one preferred embodiment of the present invention; and

FIG. 6 is a block diagram illustrating the system according to one preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

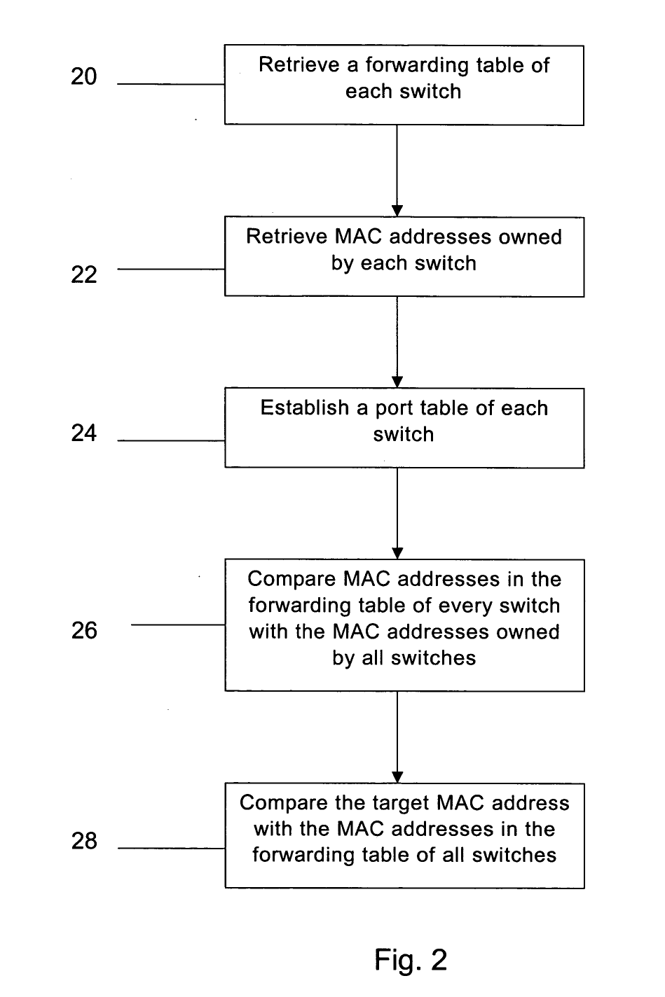

FIG. 2 is a flowchart demonstrating the method for locating the incoming port of a MAC address according to the present invention. According to the method of the present invention, first, a forwarding table of each switch is retrieved (Step 20). The forwarding table contains a list of MAC addresses. Each MAC address represents an individual packet passing through the switch. The forwarding table also includes a corresponding port where each packet enters the switch. Then, the MAC addresses owned by each switch are retrieved (Step 22).

Next, a port table of each switch is established (Step 24). The port table contains a list of all ports of the switch and the corresponding port property of each port. The port table is used to identify the port property of all ports. When a packet is sent out from one computer to another computer in the switch network, it usually enters the switch network from one switch and passes through several switches before arriving at the final destination. Therefore, the MAC address of this packet will appear in the forwarding tables of all switches that the packet has entered or passed through. Hence, whether a switch is the one that the packet enters the switch network by or whether it is the one where the packet passes through needs to be identified. When the port property of a port is classified as an end port, it means that this port is the one that the packet enters the switch network by. On the other hand, if the port property of a port is classified as an interconnecting port, it means that this port is the one that the packet passes through before arriving at the final destination. The default port property of each port is set to an end port.

The strategy to classify a port as an interconnecting port or an end port is by comparing the MAC addresses in the forwarding table of every switch with the MAC addresses owned by all switches (Step 26). If one of the MAC addresses owned by all switches matches the MAC address in the forwarding table of one particular switch, it means that the MAC address passes through this switch instead of entering the switch network from this switch. Therefore, in the port table of this switch, the port property of the port corresponding to the MAC address is changed from the default (an end port) to an interconnecting port. By this approach, all the ports in all switches can be classified as an interconnecting port or an end port.

To locate the incoming port of a target MAC address, the target MAC address is compared with the MAC addresses in the forwarding table of all switches (Step 28). If the target MAC address matches the MAC address in the forwarding table of one particular switch, and the port property of the port corresponding to the MAC address is an end port. This incoming port is the first incoming port where the target MAC address enters the switch network.

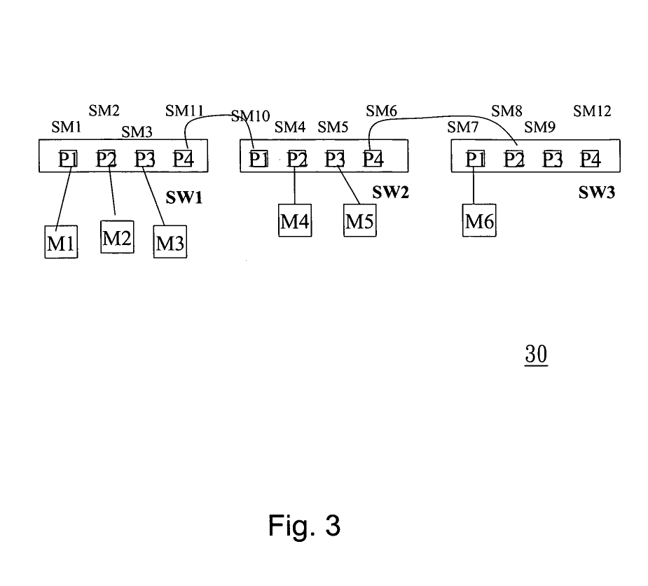

FIGS. 3 to 5 are diagrams demonstrating one preferred embodiment according to the present invention. FIG. 3 shows a switch network 30, including switches SW1, SW2 and SW3. Each switch has four ports, P1, P2, P3 and P4, and each port is connected to a computer or another switch. For example, the ports P1, P2, and P3 of the switch SW1 are connected to the computers M1, M2 and M3, respectively. The port P4 is connected to the port P1 of the switch SW2. The port P2 and P3 of the switch SW2 are connected to the computers M4 and M5, respectively. The port P4 is connected to the port P2 of the switch SW3. The port P1 of the switch SW3 is connected to the computer M6.

Furthermore, each switch has its own MAC addresses. For example, the switch SW1 has its own MAC addresses SM1, SM2, SM3 and SM11. The switch SW2 has its own MAC addresses SM10, SM4, SM5 and SM6. The switch SW3 has its own MAC addresses SM7, SM8, SM9 and SM12.

All computers in the switch network 30 can communicate with each other via the switch they are connected to. For example, via the port P1 of the switch SW2, the computer M4 can send out its packets to the switch SW1, and those packets can further be delivered to other computers connected to the switch SW1. Similarly, the computer M1 can also send out its packets to the switch SW2 via the port P4 of the switch SW1.

When the packets of the computer M4 enter the switch SW1 via the port P4 of the switch SW1, the MAC address of the computer M4 will be recorded in the forward table of the switch SW1. All packets entering the switch SW1, no matter the switch SW1 is the starting point, destination point, or interconnecting point, will be recorded in the forwarding table of the switch SW1. For example, in the forwarding table of the switch SW1, the packets of the computer M1, M2 and M3 are delivered from the switch SW1, and enter the switch SW1 via the port P1, P2 and P3, respectively. Later, they will be furthered delivered to other switches. The packets of the computer M4 and M5 connecting to the switch SW2 enter the switch SW1 via the port P4 of the switch SW1. The switch SW1 could be the destination of the packets from the computer M4 and M5, or the packets can be further delivered to other switches via the switch SW1.

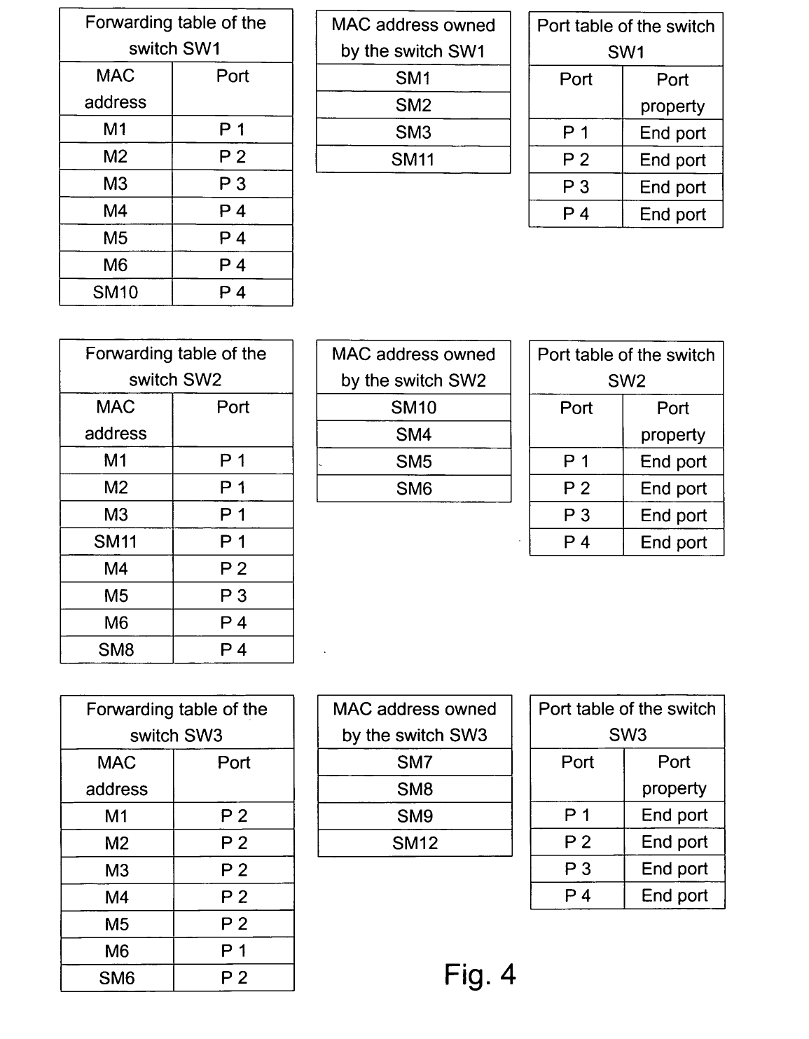

FIG. 4 shows the forwarding tables, the port tables, and the MAC addresses owned by the switch SW1, SW2, and SW3. The port table contains a list of ports of the switch, and the corresponding port property of each port. The default property of each port is set to an end port. The forwarding table and the MAC addresses owned by the switch can be retrieved by a network protocol such as SNMP (Simple Network Management Protocol) or STP (Spanning Tree Protocol). The MAC addresses owned by the forwarding tables and the switches are further transferred to a computer or a combination of computers, or transferred to the switches with operation capabilities for subsequent processing. The subsequent processing can be performed by a software, a firmware, or a hardware, and all practices are included in the scope of the present invention.

After retrieving the forwarding tables, the port table, and the MAC addresses owned by all switches in the switch network, the next step is to classify the port property of each port as an interconnecting port or an end port. While the port property is classified as an interconnecting port, it means that this port is connected to other switches. The packets are transferred to other switches through this port, and this port is not a starting point or a destination. If the port property is classified as an end port, it means that this port is not connected to other switches.

The strategy for classifying the port property is by comparing the MAC addresses in the forwarding table of every switch with the MAC addresses owned by all switches. If one of the MAC address in the forwarding table matches one of the MAC addresses owned by all switches, the port property of the port corresponding to the MAC address is changed from the default to an interconnecting port in the port table.

For example, the MAC addresses in the forwarding table of the switch SW1 are compared with all MAC addresses owned by the switches SW1, SW2, and SW3. The MAC address SM10 in the forwarding table of the switch SW1 matches the MAC address owned by the switch SW2. Therefore, in the port table of the switch SW1, the port property of the corresponding port P4 is changed from an end port to an interconnecting port. However, the MAC addresses M1, M2 and M3 in the forwarding table of the switch SW1 do not match any MAC address owned by the switches SW1, SW2, or SW3. Therefore, the port properties of their corresponding ports remain in the default port property, an end port.

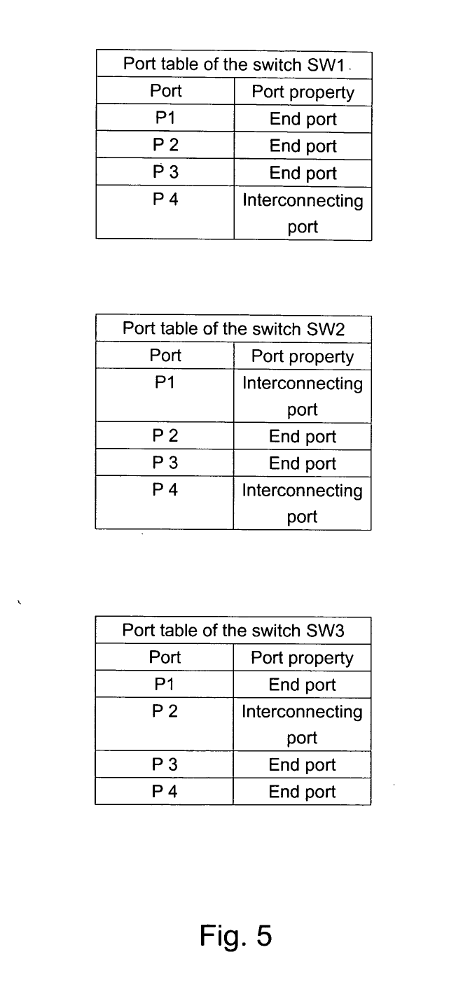

Similarly, the MAC address SM11 in the forwarding table of the switch SW2 matches the MAC address owned by the switch SW1. Therefore, the port property of the corresponding port P1 is changed to an interconnecting port. The MAC address SM8 in the forwarding table of the switch SW2 also matches the MAC address owned by the switch SW3. Therefore, the port property of the corresponding port P4 is changed to an interconnecting port. However, the MAC addresses M4, M5 and M6 in the forwarding table of the switch SW2 do not match the MAC addresses owned by any switch. Therefore, the port properties of corresponding ports P2 and P3 remain in the default end port. The MAC address SM6 in the forwarding table of the switch SW3 also matches the MAC address owned by the switch SW2. Therefore, the port property of the corresponding port P2 is changed to an interconnecting port. The MAC address M6 in the forwarding table of the switch SW3 does not match the MAC addresses owned by any switch. Therefore, the port property of the corresponding port P1 remains in the default end port. FIG. 5 shows the port tables of all switches after all ports are classified as either an interconnecting port or an end port according to the strategy described above.

Once all ports are classified into these two categories, the incoming port of a target MAC address can be located based upon the port property. To locate the incoming port of a target MAC address, the target MAC address is compared with the MAC addresses in the forwarding tables of all switches. If the target MAC address matches the MAC address in the forwarding table of a particular switch, and the port property of the corresponding port is classified as an end port in the port table, the corresponding port will be the incoming port of the target MAC address.

For example, to locate the incoming port of the target MAC address M5, first, search MAC addresses in the forwarding tables of all switches. The target MAC address M5 matches the MAC address in the forwarding tables of all switches, SW1, SW2 and SW3. However, in the port table of the switch SW1, the corresponding port P4 of the target MAC address M5 is classified as an interconnecting port. This means that the target MAC address M5 is further delivered to other switches from the switch SW1. Therefore, the port P4 of the switch SW1 is not an incoming port of the target MAC address M5. Similarly, in the port table of the switch SW3, the corresponding port P2 of the target MAC address M5 is classified as an interconnecting port. This also means that the port P2 of the switch SW3 is not an incoming port of the target MAC address M5.

However, in the port table of the switch SW2, the corresponding port P3 of the target MAC address M5 is classified as an end port. This means that the target MAC address M5 enters the switch network via the port P3 of the switch SW2. Therefore, the port P3 of the switch SW2 is the incoming port of the target MAC address M5.

Furthermore, the corresponding IP address, the host name, the user name of the target MAC address can also be provided along with the incoming port information to the network administrator. Besides, other information related to the switch that the target MAC address connects to can also be provided, such as the group name, the host name and the IP address of the switch. By providing more information related to the target MAC address, the network administrator can react more quickly and efficiently.

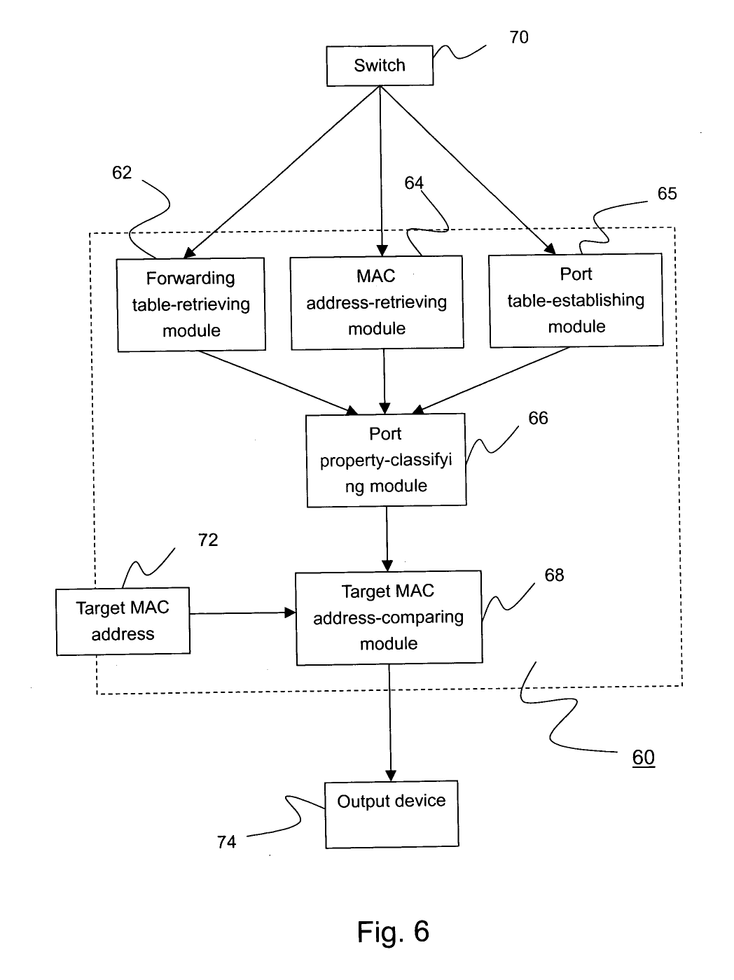

FIG. 6 is a block diagram illustrating a system for locating the incoming port of a target MAC address according to the present invention. The target MAC address locating system 60 includes a forwarding table-retrieving module 62, a MAC address-retrieving module 64, a port table-establishing module 65, a port property-classifying module 66, and a target MAC address-comparing module 68. The forwarding table-retrieving module 62 retrieves the forwarding table of each switch 70. The forwarding table of each switch 70 contains a list of all MAC addresses of packets passing through the switch 70, as well as the corresponding port whereby each packet enters the switch 70. The MAC address-retrieving module 64 retrieves a list of at least one MAC address owned by each switch 70. The port table-establishing module 65 establishes a port table of each switch. 70. The port table contains a list of all ports of the switch 70 and a corresponding port property of each port. The default port property of each port is set to an end port. The port-classifying module 66 compares the MAC addresses in the forwarding table of every switch 70 with the MAC addresses owned by all switches 70. If one of the MAC addresses owned by all switches 70 matches the MAC address in the forwarding table of the switch 70, the port property of the corresponding port of that MAC address is changed to an interconnecting port in the port table. The target MAC address-comparing module 68 compares the target MAC address 72 with all MAC addresses in the forwarding table of all switches 70. If one of the MAC addresses in the forwarding table matches the target MAC address 72, and the port property of the corresponding port of that MAC address is an end port, this port is the incoming port of the target MAC address 72. Afterward, the information regarding the incoming port of the target MAC address 72 can be output to an output device 74.

According to the target MAC address locating method of the present invention, the network administrator can locate the incoming port of an abnormal computer, such as a computer attacked by a virus. The network administrator can therefore take further steps to shut down or recover the abnormal computer more quickly and efficiently.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A method for locating an incoming port of a target MAC address, wherein the target MAC address enters a switch network via the incoming port, and the switch network includes a plurality of switches, the method comprising:
a) retrieving a forwarding table of each switch, wherein the forwarding table contains a plurality of MAC addresses of a plurality of packets passing through each switch, and a corresponding port where each packet enters each switch;
b) retrieving at least one MAC address owned by each switch;
c) establishing a port table of each switch, wherein the port table contains all ports of each switch, and a corresponding port property of each port, wherein the port property of each port is set to an end port;
d) comparing the MAC addresses in the forwarding table of each switch with the MAC addresses owned by all switches, such that if the MAC address in the forwarding table matches the MAC address owned by the switch, the port property of the corresponding port of the MAC address is changed into an interconnecting port; and
e)comparing the target MAC address with the MAC addresses in the forwarding table of each switch, wherein if the target MAC address matches the MAC address in the forwarding table, and the port property of the corresponding port of the target MAC address is the end port, the corresponding port is the incoming port of the target MAC address.

2. The method of claim 1, wherein the switches employ SNMP (Simple Network Management Protocol).

3. The method of claim 1, wherein the switches employ STP (Spanning Tree Protocol).

4. The method of claim 1, wherein further provides a corresponding IP address of the target MAC address.

5. The method of claim 1, wherein further provides a host name of the target MAC address.

6. The method of claim 1, wherein further provides a group name of the target MAC address.

7. The method of claim 1, wherein further provides a user name of the target MAC address.

8. The method of claim 1, wherein further provides a switch name of the switch that the target MAC address connects to.

9. The method of claim 1, wherein further provides an IP address of the switch that the target MAC address connects to.

10. A system for locating an incoming port of a target MAC address, wherein the target MAC address enters a switch network via the incoming port, and the switch network includes a plurality of switches, the system comprising:
a forwarding table-retrieving module, which retrieves a forwarding table of each switch, wherein the forwarding table contains a plurality of MAC addresses of a plurality of packets passing through each switch, and a corresponding port where each packet enters each switch;
a MAC address-retrieving module, which retrieves at least one MAC address owned by each switch;
a port table-establishing module, which establishes a port table of each switch, wherein the port table contains all ports of each switch and a corresponding port property of each port, wherein the port property of each port is set to an end port;
a port property-classifying module, which compares the MAC addresses in the forwarding table of each switch with the MAC addresses owned by all switches, wherein if the MAC address in the forwarding table matches the MAC address owned by the switch, changes the port property of the corresponding port of the MAC address into an interconnecting port; and
a target MAC address-comparing module, which compares the target MAC address with the MAC addresses in the forwarding table of each switch, wherein if the target MAC address matches the MAC address in the forwarding table, and the port property of the corresponding port of the target MAC address is the end port, the corresponding port is the incoming port of the target MAC address.

11. The system of claim 10, wherein the switches employ SNMP (Simple Network Management Protocol).

12. The system of claim 10, wherein the switches employ STP (Spanning Tree Protocol).

13. The system of claim 10, wherein further provides a corresponding IP address of the target MAC address.

14. The system of claim 10, wherein further provides a host name of the target MAC address.

15. The system of claim 10, wherein further provides a group name of the target MAC address.

16. The system of claim 10, wherein further provides a user name of the target MAC address.

17. The system of claim 10, wherein further provides a switch name of the switch that the target MAC address connects to.

18. The system of claim 10, wherein further provides an IP address of the switch that the target MAC address connects to.
